(19) United States
(12) Patent Application Publication
(10) Pub. No.: US 2026/0277962 A1
(43) Pub. Date: Sep. 17, 2026

(54) Digital Intelligence System

(71) Applicant: Pryon Incorporated, Raleigh, NC (US)

(72) Inventors: David Nahamoo, Great Neck, NY (US); Marie Wenzel Meteer, Arlington, MA (US); Chul Sung, Hackensack, NJ (US); Etienne Marcheret, White Plains, NY (US); Steven John Rennie, Yorktown Heights, NY (US); Ellen Eide Kislal, Leawood, KS (US); Vaibhava Goel, Chappaqua, NY (US)

(21) Appl. No.: 19/164,062

(22) PCT Filed: Mar. 11, 2024
(86) PCT No.: PCT/US2024/019367

§ 371 Date: Sep. 10, 2025

Related U.S. Application Data
(60) Provisional application No. 63/451,320, filed on Mar. 10, 2023.

(51) Int. Cl. G06F 16/3331; G06F 16/3329; G06N 3/045; G06N 3/0475; G06N 3/096; G06N 5/04

(52) U.S. Cl. CPC G06F 16/3331; G06F 16/33295; G06N 3/045; G06N 3/0475; G06N 3/096; G06N 5/041

(57) ABSTRACT

A question answering system is configured to extract answers to queries from a collection of data. The system includes an extractive stage configured to receive a query and to determine one or more answers to the query from the collection of data and one or more generative large language model stages configured to pre-process the query before it is provided to the extractive stage and/or to post-process the answers to the query.

### CROSS-REFERENCES TO RELATED APPLICATIONS

This application claims the benefit of U.S. Provisional Application No. 63/451,320 filed Mar. 10, 2023, the entire contents of which are incorporated herein by reference.

### BACKGROUND OF THE INVENTION

This invention relates to a digital intelligence system, and more particularly to such a system that uses a combination of general large language model-based components and problem-specific components.

### SUMMARY OF THE INVENTION

Digital intelligence includes encoding information and skills in digital form in a way that can be used to solve problems that might otherwise require human intelligence, or as technology evolves to solve problems that are beyond the capabilities of human intelligence of individual people. For example, in particular domains, for instance in medicine, a human expert may apply their skills to access information (e.g., by reading journal papers) and interacting with a patient via language-based and data-based interaction, and use their problem solving skills to make a diagnosis, and then communicate that diagnosis to the patient or other practitioners. Some of those component tasks are somewhat general, for example, in steps involving taking in information from language-based sources or providing derived information based, and other tasks are tailored to a specific problem, for instance based on differential diagnosis using information that is gleaned.

There has been recent significant interest large language models (LLMs), such as autoregressive models (e.g., Generative Pre-trained Transformer, GPT) and bidirectional models (e.g., Bidirectional Encoder Representations from Transformers, BERT) that are trained on vast amounts of text data from a wide range of sources. Such models have the advantage of being trainable in an unsupervised manner without any need for additional human labeling/annotation of the data as the inherent word sequences in the text carry all the required annotation for supervised training thereby allowing them to be highly parameterized (e.g., in the order of 10¹² of free parameters) as the amount of available text data is enormous, at least one order of magnitude larger than the parameters size. On the other hand, because of the wide variety of sources of training data, the models are not particularly tailored to any specific problem or to any particular data domain.

Although LLMs are not necessarily tailored to any particular problem, they can be used to address various problems whose solution may be addressed according to form of the input text. For example, the same LLM could be used to perform a summarization task by inputting a text input such as “Summarize the following statement: <statement to be summarized>” resulting in the output word sequence being tailored to a summary of the statement, while an input such as “Perform the computation, <word-based math problem>” may result in text that solves the math problem. However, although the LLM may provide adequate problem solving in some domains, there are limits to its abilities, for example, due to the combinatoric for problem specifications. Taking for example, use of an LLM for solving arithmetic problems may have limits, an input such as “Perform the computation one plus two” may yield an output “The sum is three”, while input such as “Perform the computation one million, two hundred and thirty four thousand, five hundred and sixty seven plus eighty nine” may not yield an accurate answer. A possible explanation is that encoding all the addition and multiplication tables that would be needed in an LLM would likely exceed even the massive parameterization of such models as these systems don't have the ability to conceptualize and abstract away a localized algorithm that can be repeated to add numbers of any length, such as the carryover in addition.

In a general aspect, a digital intelligence system makes use of LLMs for some components, and leverages capabilities of such components with problem specific components. Taking the math word problem as an example, an LLM may be well-suited to rephrase a “word problem” a child may encounter in elementary school in a canonical form or in algebraic notation, but may not be well-suited to actually determine the answer. For example, an LLM may be able to handle a transformation “How do you solve the math problem ‘A movie theatre has 25 rows of seats with 20 seats in each row. How many seats are there in total?’” could possibly yield an output “The total number of seats is computed as 25 times 20.” But the LLM might not be well suited to actually performing the multiplication.

To augment the capabilities of the LLM based components, which below are referred to as “LLM Learners”, a digital intelligence system is augmented with problem-specific “solvers”, which may also be based on underlying large language model training and referred to as “LLM Solvers”. For example, in the math word problem domain, a problem-specific solver may be trained to map linguistic input to a function or application programming interface (API) representation of the problem. In the simple case of addition, the mapping may be from “one million, two hundred and thirty four thousand, five hundred and sixty seven plus eighty nine” to “ADD(1234567, 89)”, which can then be evaluated by a math library software program. While addition and multiplication may be particularly simple, such an approach may be trained to map linguistic input to formulas representable by a library of functions as might be found in Microsoft Excel with complex mappings such as “What is the performance of a stock where I bought 100 shares on January 1 for $100 and 200 shares on July 1 for $220 and sold on Dec. 31 for $400” to an internal rate of return function call (IRR). Such a solver could be referred to as “natural language to API (NL2API)”.

A system may have a number of different solvers, including for example a mapping from natural language (NL) to database access functions (e.g., in SQL syntax), NL to mathematical (e.g., algebraic) notation (e.g., in a syntax that is solvable by back-end systems such as Wolfram Alpha), or NL to logic notation. Some solvers may be more complex, for example, involving complex question-answering technologies. However, it should be evident that if a user can provide a variety of types of inputs, it is not a priori known which solver is appropriate.

One way to provide access to a variety of solvers uses a structured hybrid arrangement. For example, in a question-answering application, a user's query may be processed by an LLM learner for example to resolve language ambiguities, replace antecedent references (e.g., “it”) with explicit terms, or paraphrase into a canonical form. Such preprocessing may improve the performance of the overall question-answering system, which may be tailored to a particular domain or content collection, by avoiding a need to encode general linguistic aspects that would be needed to accept a wide range of forms of user input. Similarly, in a limited domain question answering system in which user questions are resolved based on a collection of documents (e.g., HR manuals for a corporation), that source collection may be preprocessed by an LLM learner for aspects such as disambiguation or summarization. Locating an answer in a disambiguated document may be more robust than attempting to locate an answer in an ambiguous source text. An LLM learner may also be used to generate training data including automatic creation of question-answer pairs from a source collection as well as automatic generation of many paraphrases for every question of every automatically created QA. Such preprocessing of queries and training collections are then provided to configure a domain-specific question-answering solver, which is usually a lot more accurate as the QAs represent the task at hand. The output of the question-answering solver may be passed through a LLM learning for summarization of answers found by the solver, or rephrasing to improve output qualities such as fluency.

In some implementations, LLM solvers start with one of these LLMs (for instance, BERT, Electra) and then they are fine-tuned for a specific task, for instance information retrieval question answering (IRQA), by collecting a large number of QAs (e.g., from the SQUAD dataset) to train a combination of Reading Comprehension (focusing on the most concise and specific answer in a piece of document (e.g., a View or Paragraph) as well as Detail Match (to find the most appropriate piece of document, e.g. View or Paragraph). The LLM that is tuned in this way works efficiently on any IRQA domain, e.g., a customer's field services Collection, without the need to fine-tune for this new collection. Such a model is a “zero-code” model because it is a transferable model across essentially all Collections for the IRQA task. This IRQA system can be used to Choose/Select the most appropriate document from the Collection that has been ingested. To speed up the process, a Fast Match can be used to eliminate a large number of possibilities and allow the document retrieval to operate on a very small subset, e.g., taking 1M Views to 800 views.

In some implementations, the LLM learners are designed differently than LLM solvers. First, they may combine many tasks together as an LLM predictor. For example, they combine Translation data, QA data, Paraphrase data, etc., where the system learns that by simply tagging each task with some simple linguistic prompt to create one model that does all of these tasks. Hence, they are a Multi-Task LLM. However, it turns out that the performance of the system requires fine-tuned data, for example, as has been for ChatGPT by having a large number of humans correcting the mistakes of the system on task dependent activities such as IRQA by allowing the users describe the task they want to perform through their own stated “Prompts” for Task Description, followed by the item that the task should be applied to. This fine-tuning step has delivered a big progress from GPT-3 to ChatGPT. In addition, the data collection and Human In The Loop Reinforcement Learning allowed for introducing Multi-Turn Interaction capability offering conversational capability for resolving language contraction such as as CoRef and Ellipsis, (see for example, “Ellipsis Resolution as Question Answering: An Evaluation” https://www.arxiv-vanity.com/papers/1908.11141/). Such LLM learners are Generative (Predictive based) machinery that produce output based on the parameters that they have learned in the building process of LLM Learners. As such they use a common architecture and common data for training (pre-trained and fine-tuned with human feedback) which can be used on many tasks. In addition, they have a generalization capability that they can quickly even learn to do tasks that have not been seen in the training step through “a few shot examples”. Hence, they are called LLM “few shot” Learners.

In general, LLM solvers on the other hand are generally selective/extractive (classification based), machinery that while they use the same Transformer architecture as LLM Learners, they fine-tune on a specific task using specific task data, e.g. IRQA system being fine-tuned on SQUAD data. A significant difference between the two is that Learners predict and generate the response from a parametric memorization of all the data they have seen during their build process, while the solvers can be considered to be classifiers that select one of the short/concise part of a collection or algorithmically determine an answer in a particular domain.

A consequence of the approaches to constructing LLM learners as compared to LLM solvers is that LLM learners have the possibility to “hallucinate” new responses that could be correct or completely wrong. On the other hand, an LLM solver may select from the Collection that has been authenticated by a human. That is, an LLM solver may make an algorithmic error of selecting a wrong answer, but it doesn't make up answers like the LLM learners do. On the other hand, LLM learners may offer better fluency and conversational capability. Finally, the LLM learners can have significant privacy issues such as the requirement to remove the profile of an employee from being visible when the employee leaves the company, a GDPR requirement.

In a specific aspect, a natural language processing system, includes: a set of one or more LLM solvers, each LLM solver being configured for a particular respective problem type, a set of one or more LLM learners, the LLM learners providing general solutions not particularly tailored to the problem types of the LLM solvers, and control components coupling the set of LLM solvers and the LLM learners to pass data between said solvers and learners in response to a user input to provide a user output.

In a general aspect, a question answering system is configured to extract answers to queries from a collection of data. The system includes an extractive stage configured to receive a query and to determine one or more answers to the query from the collection of data and one or more generative large language model stages configured to pre-process the query before it is provided to the extractive stage and/or to post-process the answers to the query.

Aspects may include one or more of the following features.

At least some of the generative large language models may be collection-specific. The generative large language models may be fine-tuned and/or prompt tuned according to the collection of data. At least some of the generative large language models may be collection agnostic. At least some of the generative large language models may be collection-specific and at least some of the generative large language models may be collection agnostic.

The one or more generative large language model stages configured to pre-process the query may include a generative large language model stage for query disambiguation and a generative large language model stage for query canonicalization. The one or more generative large language model stages configured to process the query may further include a generative large language model for out of domain query detection and a generative large language model for chitchat detection. The extractive stage may include an extractive large language model configured to generate a number of answers to the query.

The one or more generative large language model stages configured to post-process the answers to the query may include a summary and fluency generative large language model stage configured to process the query and the number of answers to generate a single answer to the query. The system may include a second extractive stage configured to determine if the single answer is attributable to the collection of data. The one or more generative large language model stages configured to process the answers may include a hallucination detection large language model stage configured to determine whether the single answer is a hallucination.

The system may include a structured data retrieval stage and an orchestration module, wherein the one or more generative large language model stages are configured to process the answers are configured to generate an unstructured answer to the query and the structured data retrieval stage is configured to generate a structured answer to the query, and the orchestration module is configured to choose the best answer from the structured answer and the unstructured answer. The orchestration module may choose the best answer based on a comparison of a first confidence score associated with the structured answer and a second confidence score associated with the unstructured answer.

The extractive stage may include a relational database. The one or more generative large language model stages configured to pre-process the query may include a generative large language model configured to convert a natural language query to a SQL query.

In another general aspect, a method for extracting answers to queries from a collection of data includes processing a query in an extractive stage to determine one or more answers to the query from the collection of data and pre-processing the query before it is provided to the extractive stage using one or more generative large language model stages and/or post-processing the answers to the query using one or more generative large language model stages.

In another general aspect, software embodied on a non-transitory, tangible computer-readable medium includes instructions for causing a computing system to process a query in an extractive stage to determine one or more answers to the query from the collection of data and pre-process the query before it is provided to the extractive stage using one or more generative large language model stages and/or post-process the answers to the query using one or more generative large language model stages.

In another general aspect, a method for training a collection-specific generative large language model for forming a SQL representation of a natural language query includes processing a number of SQL queries in a generative large language model to determine a corresponding number of natural language representations of the SQL queries, training an intermediate generative large language model to convert natural language representations of SQL queries to SQL queries using the number of SQL queries and corresponding number of natural language representations of the SQL queries, processing a number of collection-specific natural language queries using the intermediate generative large language model to convert the collection-specific natural language queries to collection-specific SQL queries, and training the collection-specific generative large language model to convert natural language queries to collection-specific SQL queries using the number of collection-specific natural language queries and the corresponding number of collection-specific SQL queries.

Among other advantages, aspects combine an extractive large language model (which provides efficiency, ease of interpretability, domain adaptability, and does not generate misinformation) with one or more generative large language models (which can generate creative and novel output, expand upon content, adapt to unseen data, and handle ambiguity and uncertainty) to form a system that has all the power and flexibility of a generative large language model without the lack of attribution and hallucinations that are commonly associated with generative large language model systems. Working together, the extractive and generative large language models are able to compensate for each other's weaknesses.

Other features and advantages of the invention are apparent from the following description, and from the claims.

### BRIEF DESCRIPTION OF THE DRAWINGS

FIG. 1 is a hybrid LLM system.

FIG. 2 is another representation of the hybrid LLM system of FIG. 1.

FIG. 3 is a query pre-processing module.

FIG. 4 is a structured question-answering module.

FIG. 5 is an unstructured question-answering module with successful attribution matching.

FIG. 6 is an unstructured question-answering module performing hallucination detection.

FIG. 7 is a schematic block diagram of a system for training LLMs.

### DETAILED DESCRIPTION

### 1 Overview

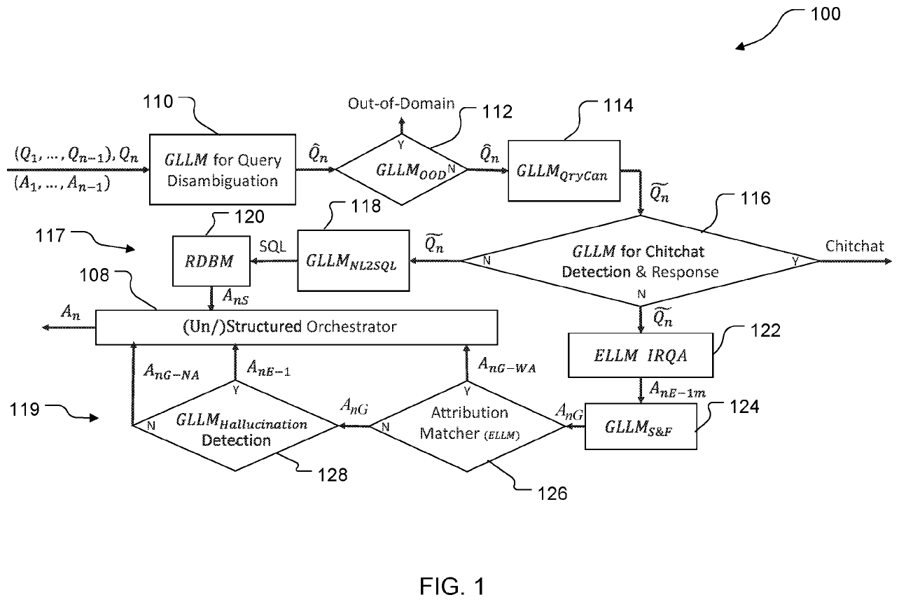

Referring to FIG. 1, a first example of a question answering system 100 (sometimes referred to as a “Hybrid LLM” system) is configured to answer questions about a specific collection of data (e.g., all the documentation for a large corporation). Previous approaches to this type of question-answering task process a “raw” input query in an LLM-based extractive information retrieval-question answering (ELLM IRQA) system to identify one or more answers to the input query from the collection of data. One such approach is described in PCT Application No. PCT/US2021/039145, the entire contents of which are incorporated herein by reference.

The Hybrid LLM question-answering system 100 builds on that previous approach by using an ensemble of large language models, tuned to the collection of data, to pre-process the query and post-process the answers in a way that improves the overall question-answering performance of the system. In some examples, the ensemble of large language models includes both extractive large language models (ELLMs) and generative large language models (GLLMs). Very generally, ELLMs are LLMs configured to extract information from existing data (e.g., a segment of a document) using a transformer model (e.g., a bidirectional encoder representations from transformers (BERT) model). GLLMs are configured to generate new text based on a given prompt and possibly given context.

As is described in greater detail below, the system 100 pre-processes the input query, Qₙ in a series of LLMs for query disambiguation 110, out-of-domain detection 112, query canonicalization 114, and chit-chat detection 116 before any question-answering steps. The pre-processed query, \tilde{Q}ₙ is then processed in both a structured question-answering path 117 and an unstructured question-answering path 119, each of which generates an answer that is provided to an orchestrator 108. The orchestrator 108 determines which of the answers to output as the best answer to the query, Aₙ.

In the structured question-answering path 117, the pre-processed query, \tilde{Q}ₙ is processed in an NL2SQL LLM 118 to convert the query from a natural language (NL) representation to a structured query language (SQL) representation 118. The SQL representation of the query is then used to determine an answer, A_{nS} from structured data (e.g., a relational database) 120. The answer from structure data, A_{nS} is provided to the orchestrator 108.

In the unstructured question-answering path 119, the pre-processed query, \tilde{Q}ₙ is used by an ELLM IRQA 122 to generate m candidate answers, A_{nE-1m}. The m candidate answers, A_{nE-1m} are processed in a summary and fluency GLLM 124, which generates a single answer, A_{nG} based on the m candidate answers, A_{nE-1m} (in some examples, the summary and fluency LLM 124 may be implemented using an ELLM). The single answer, A_{nG} can be selected from one of the candidate answers, a combination of the candidate answers, or even a completely different answer. An attribution matcher 126 then determines whether the single answer, A_{nG} is attributable to one of the m candidate answers, A_{nE-1m}. If yes, then the single answer, A_{nG} is provided to the structured orchestrator 108 as A_{nG-WA}. If the single answer, A_{nG} is not attributable to one of the m candidate answers, A_{nE-1m}, then a hallucination detector 128 determines whether it is an incorrect “hallucination.” If the single answer, A_{nG} is not a hallucination, then it is provided to the orchestrator 108 as A_{nG-WA}. Finally, if the single answer, A_{nG} is a hallucination, the top answer from A_{nE-1m} it is provided to the orchestrator 108 as A_{nE-1}.

As is noted above, the orchestrator 108 selects the best answer from the answer provided by the structured path 117 and the answer provided by the unstructured path 119 (e.g., based on confidence scores associated with the answers), and outputs that answer as the system's answer to the query, Aₙ.

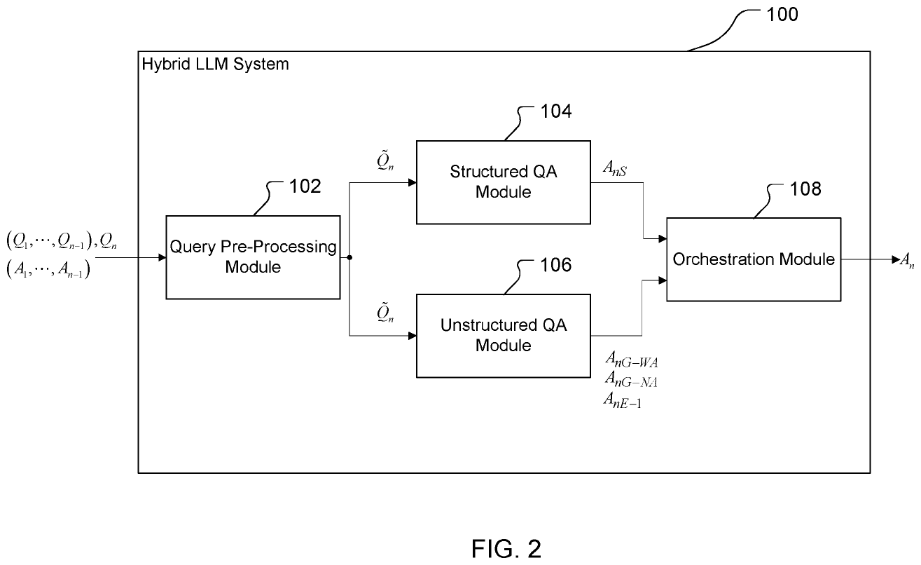

Referring to FIG. 2, another example of a Hybrid LLM question-answering system 100 is configured to answer questions about a specific collection of data (e.g., all the documentation for a large corporation) using an ensemble of large language models (LLMs) tuned to the collection. At a high level, the system 100 receives a query, Qₙ (e.g., a question that may be answerable using the collection) and contextual information (e.g., a set of one or more previously processed queries, (Q₁, . . . , Qₙ₋₁) and corresponding answers to the queries, (A₁, . . . , Aₙ₋₁)) as input and processes the input to generate an answer, Aₙ to the query.

The system 100 includes a number of modules, at least some of which include large language models (generative and/or extractive) tuned to operate on the collection of documents. For example, the system 100 includes a query pre-processing module 102, a structured question-answering (QA) module 104, an unstructured question-answering (QA) module 106, and an orchestration module 108. As is evident from the description herein, except for the ELLM IRQA 122, the system preferably uses GLLMs in the query pre-processing module 102, the structured QA module 104, and the unstructured QA module 106.

As is described in greater detail below, the query pre-processing module 102 processes the query, Qₙ using the contextual information (Q₁, . . . , Qₙ₋₁), (A₁, . . . , Aₙ₋₁)) to generate a pre-processed query, \tilde{Q}ₙ, which is a disambiguated and canonicalized version of the input query, Qₙ. The pre-processed query, \tilde{Q}ₙ is provided to both the structured QA module 104 and the unstructured QA module 106. The structured QA module 104 accesses a structured set of data (e.g., a SQL database) using the pre-processed query, \tilde{Q}ₙ to generate a first candidate answer to the query, A_{nS}. The LLM-based QA module 106 processes \tilde{Q}ₙ using a series of LLMs to generate a second candidate answer to the query (represented as A_{nG-WA}, A_{nG-NA}, or A_{nE-1}, described in greater detail below).

The orchestration module 108 receives the first and second candidate answers and determines which of the two candidate answers to output as the final answer, Aₙ (e.g., based on a comparison of confidence scores associated with the two candidate answers).

### 2 Query Pre-Processing Module

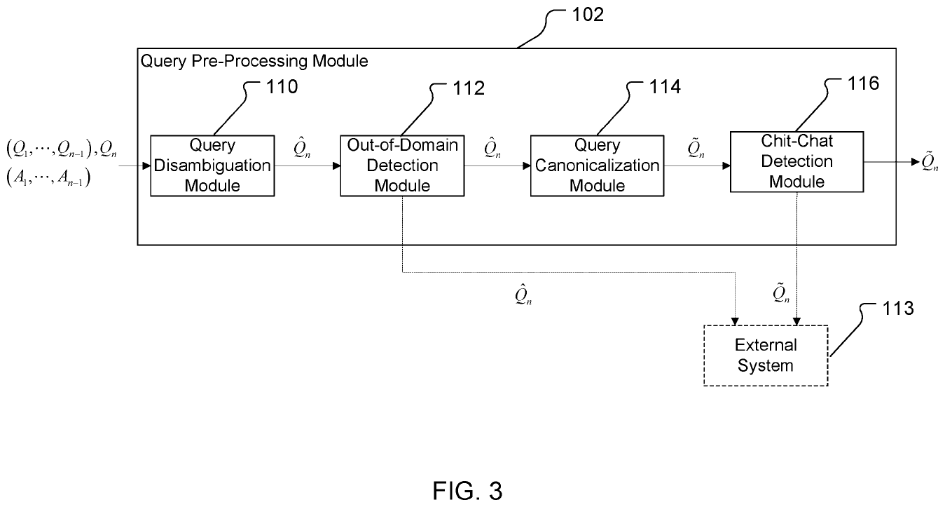

Referring to FIG. 3, in some examples, the query pre-processing module 102 includes a query disambiguation module 110, an out-of-domain detection module 112, a query canonicalization module 114, and a chit-chat detection module 116.

### 2.1 Query Disambiguation Module

The query disambiguation module 110 is configured to process the input query, Qₙ using the contextual information, (Q₁, . . . , Qₙ₋₁), (A₁, . . . , Aₙ₋₁)) to generate a disambiguated input query, \hat{Q}ₙ. For example, the input query “How do I request it?,” taken in isolation, is ambiguous because we don't know what the word “it” refers to. But if Qₙ₋₁ is “What is the company's paid time off policy?” and Aₙ₋₁ is “The company allows 4 weeks of paid time off,” then we know that “it” in Qₙ likely refers to “paid time off.” The query disambiguation module 102 is configured to make that association from the input query and the contextual information to generate \hat{Q}ₙ as “How do I request paid time off?”.

In some examples, the query disambiguation module 110 is implemented as a generative large language model (GLLM) that is specifically tuned for the query disambiguation task (as described in greater detail below). It is noted that the query disambiguation example above is an example of referential disambiguation—the clarification of ambiguous references to entities or concepts (e.g., resolving pronouns to their antecedents or determining which entity a descriptive phrase refers to). But the query disambiguation module 110 can resolve other types of ambiguities such as:
lexical ambiguities (e.g., ambiguities at the word level, where a single word has multiple meanings such as determining whether “bank” refers to a financial institution or the side of a river),
syntactic ambiguities (e.g., ambiguities in sentence structure or grammar such as in the sentence “I saw the man with the telescope,” syntactic disambiguation helps determine whether “with the telescope” describes the man or the action of seeing),
semantic ambiguities (e.g., ambiguities in meaning that can be resolved based on the broader context. For example, distinguishing between “apple” as a fruit or as a tech company),
named entity ambiguities (e.g., ambiguities in the correct entity referenced by a proper noun, such as a case where “Washington” could refer to the state, the capital city, or a historical figure),
word sense ambiguities (e.g., ambiguities in the correct sense of a word in a given context. For example, disambiguating “bat” as either a flying mammal or a sports equipment based on its usage in a sentence), and
intent ambiguities such as ellipsis (e.g., Q1: How old is David? Q2: How about Robin?).

### 2.2 Out-of-Domain Detection Module

The disambiguated input query, \hat{Q}ₙ is provided to the out-of-domain detection module 112, which processes the disambiguated query to determine whether it is in-domain (i.e., directed to the specific collection of data associated with the system 100) or is out-of-domain (i.e., is unrelated to the specific collection of data associated with the system 100 or is outside the scope or expertise of the system). If the disambiguated input query, \hat{Q}ₙ is in-domain, then the disambiguated input query, \hat{Q}ₙ is passed to the query canonicalization module 114 for further processing. If the disambiguated input query, \hat{Q}ₙ is out-of-domain, then the out-of-domain detection module 112 provides the disambiguated query to an external system 113 (e.g., another LLM) for processing.

For example, if the collection of data associated with the system 100 is a collection of corporate documents that includes documents pertaining to the corporation's vacation policy, the out-of-domain detection module 112 would determine that the query “How do I request paid time off?” is in-domain and provide the query to the query canonicalization module 114 for further processing. On the other hand, the out-of-domain detection module 112 would determine that the query “Who was the fourth president of the United States?” is out-of-domain and would provide the query to an external system.

In some examples, the out-of-domain detection module 112 is implemented as a generative large language model (GLLM) that is specifically tuned for the out-of-domain detection task (as is described in greater detail below) and to output an “in” or “out” of domain answer (possibly associated with a confidence score). In other examples, the out-of-domain detection module 112 is implemented as a classifier (e.g., a deep neural network-based classifier) that is specifically tuned for the out-of-domain detection task.

### 2.3 Query Canonicalization Module

As is noted above, if the disambiguated input query, \hat{Q}ₙ is in-domain, the query is passed to the query canonicalization module 114, which processes the query to generate a canonical query, \tilde{Q}ₙ. For example, if the disambiguated input query, \hat{Q}ₙ is “How do I request vacation time?”, the query canonicalization module 114 might be configured to generate a canonical query, \tilde{Q}ₙ that replaces “vacation time” with “paid time off” because “paid time off” is the term used in the collection of data. The canonical query, \tilde{Q}ₙ in that case would be “How do I request paid time off?”.

In some examples, the query canonicalization module 114 is implemented as a generative large language model (GLLM) that is specifically tuned for the query canonicalization task (as described in greater detail below). It is noted that the query canonicalization example above is an example of synonym mapping for query canonicalization. However, it should be recognized that the query canonicalization module 114 can perform other forms of canonicalization including but not limited to case normalization, word stemming, word reordering, stop word removal, and spelling correction.

### 2.4 Chit-Chat Detection Module

The canonical query, \tilde{Q}ₙ is provided ot the chit-chat detection module 116, which processes the canonical query to determine if it is chit-chat (i.e., a casual, social, or non-task-oriented query) rather than a task-oriented or goal-driven query. For example, if the canonical query, \tilde{Q}ₙ is “How do I request paid time off?”, then the chit-chat detection module 116 would determine that the query is task-oriented (i.e., it is directed to the task of question answer for a collection of documents). In that case, the canonical query, \tilde{Q}ₙ is sent out of the query pre-processing module 102 for further processing in the hybrid LLM system 100. On the other hand, if the canonical query, \tilde{Q}ₙ is “Wouldn't it be nice to take a vacation right about now?”, then the chit-chat detection module 116 would recognize the query as a casual query that is not directed to the task of question answering for a collection of documents. In that case, the chit-chat detection module 116 provides the canonical query, \tilde{Q}ₙ to an external system 113 (e.g., another LLM) for processing.

In some examples, the chit-chat detection module 116 is implemented as a generative large language model (GLLM) that is specifically tuned for the chit-chat detection task and outputs a “true” or “false” answer indicating whether the input query is chit-chat (possibly associated with a confidence score). In other examples, the chit-chat detection module 116 is implemented as a classifier (e.g., a deep neural network-based classifier) that is specifically tuned for the chit-chat detection task.

### 3 Structured QA Module

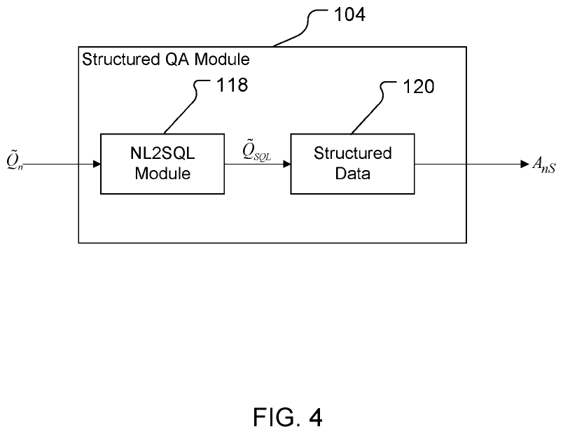

Referring to FIG. 4, as is described above, the canonical query, \tilde{Q}ₙ is output from the query pre-processing module 102 to the structured QA module 104, which uses the query to determine an answer, A_{nS} from structured data. In some examples, the structured QA module 104 includes a natural-language to SQL (NL2SQL) module 118 and structured data 120 that can be queried using SQL statements (e.g., a relational database management system).

The NL2SQL module 118 is configured to receive a natural language query such as the canonical query, \tilde{Q}ₙ and transform the query into a corresponding SQL statement, \tilde{Q}_{SQL}. For example, if the canonical query were “Retrieve the names and ages of all employees who work in the Sales department,” then the NL2SQL module 118 would generate the following SQL query, \tilde{Q}_{SQL}:
SELECT name, age
FROM employees
WHERE department=‘Sales’;

The SQL query, \tilde{Q}_{SQL} is then used to access the structured data 120 to determine the answer, A_{nS}. For example, if the structured data 120 includes the following table of data titled “employees”:

| name | age | department |
|---|---|---|
| John | 35 | Sales |
| Emily | 28 | HR |
| Michael | 40 | Sales |
| Sarah | 32 | Sales |
| David | 45 | IT |

The answer, A_{nS} from the SQL query would be:

| name | age |
|---|---|
| John | 35 |
| Michael | 40 |
| Sarah | 32 |

As is noted above, in some examples, the answer, A_{nS} is also associated with a confidence score representing a degree of confidence that the answer is correct. In some examples, the confidence score determined based on how certain the NL2SQL module 118 is that the SQL query, \tilde{Q}_{SQL} accurately represents the natural language, canonical query, \tilde{Q}ₙ.

In some examples, the NL2SQL module 118 is implemented as a generative large language model (GLLM) that is specifically tuned for the task of transforming natural language queries to SQL queries (as is described in greater detail below) and as described in PCT/US2023/027315, the entire contents of which are incorporated herein by reference.

### 4 Unstructured QA Module

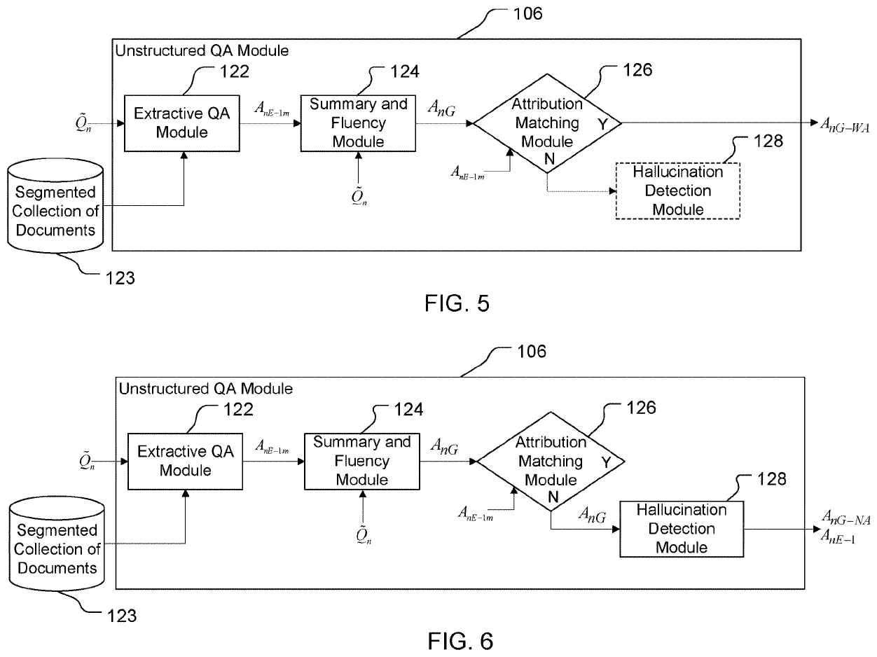

Referring to FIG. 5, as is described above, the canonical query, \tilde{Q}ₙ is also output from the query pre-processing module 102 to the unstructured QA module 106, which uses the query to determine an answer (represented as A_{nG-WA}, A_{nG-NA}, or A_{nE-1}) using a set of large language models. In some examples, the unstructured QA module 160 includes an extractive QA module 122, a summary and fluency module 124, an attribution matching module 126, and a hallucination detection module 128.

### 4.1 Extractive QA Module

The extractive QA module 122 receives the canonical query, \tilde{Q}ₙ and a segmented representation of the collection of documents 123 as input and processes the input to generate a set of m document segments, A_{nE-1m} that best answer the query.

### 4.1.1 Single Stage Question Answering

In some examples, the extractive QA module 122 is implemented as an IRQA (i.e., an extractive LLM for information retrieval) that uses a transformer model generally of a type described in Devlin, Jacob, Ming-Wei Chang, Kenton Lee, and Kristina Toutanova. “BERT: Pre-training of deep bidirectional transformers for language understanding.” arXiv preprint arXiv:1810.04805 (2018), or Wolf, Thomas, Lysandre Debut, Victor Sanh, Julien Chaumond, Clement Delangue, Anthony Moi, Pierric Cistac et al. “Huggingface's transformers: State-of-the-art natural language processing.” arXiv preprint arXiv:1910.03771 (2019), which are incorporated herein by reference. Generally, by “transformer model”, we mean a multilayer neural network that learns context and thus meaning by tracking relationships in sequential data like the words in a sentence. Transformers use a technique referred to as “attention” or “self-attention”, to detect subtle ways even distant words in a series influence and depend on each other. The reader is referred to Vaswani, Ashish, Noam Shazeer, Niki Parmar, Jakob Uszkoreit, Llion Jones, Aidan N. Gomez, Łukasz Kaiser, and Illia Polosukhin. “Attention is all you need.” Advances in neural information processing systems 30 (2017), for further discussion of such attention mechanisms.

As is mentioned above, the extractive QA module 122 operates on a segmented representation of the collection of documents 123. In some examples, the segmented representation of the collection of documents 123 is formed in an ingestion stage, where each document is divided into multiple document segments (e.g., by paragraph or by number of words, such as 200-word segments).

In a brute-force approach, the extractive QA module 122 processes each document segment in the segmented representation of the collection of documents 123 to determine whether the document segment includes an answer to the input query. To do so, the extractive QA module 122 forms an input to the transformer model as a concatenation of words (e.g., a concatenation of the input query and the document segment). The concatenation is augmented, for example, to add a “[CLS]” token at the start of the input, and a separator “[SEP]” between the question words and the document segment words, and a further “[SEP]” at the end of the input. The output includes an output corresponding to each of the input words (i.e., in a one-to-one relationship). As discussed below in regard to training, the output corresponding to the [CLS] token can be considered to be an output that represents the input as a whole, while each word of the question or the document segment also has a separate output. In the transformer model, each of the input words is first transformed into an embedding vector that is a mixture of a word embedding vector representing the word itself, an embedding vector representing the word being part of a question or part of the document segment and a position embedding representing the position in the sequence of input words. This sequence of embeddings is then passed through multiple layers of the transformer model, where these layers implement the attention mechanisms discussed above, with the final layer providing the outputs corresponding to the input words.

Three components of the outputs are of particular use in determining whether the document segment answers the input query. The output corresponding to the [CLS] token includes or is used to compute (e.g., with further neural network layers) a score that the document segment includes an answer to the question. In this way, by processing the question with multiple different document segments, the segments with the best scores can be identified as being the best candidates for containing the answer. Outputs corresponding to words in the document segment include or are used to compute two scores, or corresponding to whether that word is the start of an answer to the question, and another corresponding to whether the word is the end of the answer. Together, these scores can be used to identify the best subsequence of words that form the answer to the question, and the scores are used as further evidence of whether the subsequence is a true answer to the question.

The m document segments with the best scores, A_{nE-1m} are output from the extractive QA module 122. In some examples, the m document segments include all document segments with scores with a certain distance from the document segment with the top score.

Turning to training of the extractive QA module 122, a dataset of questions and corresponding document segments with identification (annotation) of whether an answer appears in the segment and the start and end of such an answer are provided. For example, the dataset is formed by manual curation of questions and answers in a particular domain. Training of the module's transformer generally makes use of conventional iterative updating of model parameters, for example, using gradient updates (e.g., using backpropagation) using small batches of the annotated question-segment pairs. The transformer model is usually initialized on another task, for example, in a masked language model task, and then the model parameters are further trained on the training dataset.

### 4.1.2 Multistage Question Answering

As in the example described above, with sufficient computation capacity, the identifying document segments that answer the query might be performed on all document segments that have been ingested into the system to find a best (or possibly a set of best) answer to the question. But such exhaustive searching may not be feasible. In another example, the extractive QA module 122 implements a multistage question answering scheme that uses transformer models in both a fast match stage, as well as in a detailed match stage.

There are three phases to such a multistage approach: training, ingestion, and query runtime. Turning first to the ingestion stage, a repository of documents is processed so that each document is divided into multiple document segments, for example, each with about a paragraph or approximately 200 words. In the query runtime stage, given a question, the system locates an answer in at least one of the ingested segments using the multistage approach. This locating of an answer uses the Fast Match (FM) to first identify a relatively small subset of the segments, for example, in the order of 100's or 1000's of segments. Then the locating uses the Detailed Match (DM) to determine a specific answer in one or more of that small subset of segments.

In this discussion (and in the appended claims), we may refer to the words or the word sequence in a document segment or in a query. It should be understood that by “words” we may mean portions of words that are broken up, for example, by linguistic rules, such as diving “running” into “run” “-ing”, or perhaps by coalescing words into synthesized compound words. Therefore, any reference to words must be understood to encompass such word parts or coalesced words.

Turning to details of an implementation of the Detailed Match, a transformer model is used generally of a type described in Devlin, Jacob, Ming-Wei Chang, Kenton Lee, and Kristina Toutanova. “BERT: Pre-training of deep bidirectional transformers for language understanding.” arXiv preprint arXiv:1810.04805 (2018), or Wolf, Thomas, Lysandre Debut, Victor Sanh, Julien Chaumond, Clement Delangue, Anthony Moi, Pierric Cistac et al. “Huggingface's transformers: State-of-the-art natural language processing.” arXiv preprint arXiv:1910.03771 (2019), which are incorporated herein by reference. Generally, by “transformer model”, we mean a multilayer neural network that learns context and thus meaning by tracking relationships in sequential data like the words in a sentence. Transformers use a technique referred to as “attention” or “self-attention”, to detect subtle ways even distant words in a series influence and depend on each other. The reader is referred to Vaswani, Ashish, Noam Shazeer, Niki Parmar, Jakob Uszkoreit, Llion Jones, Aidan N. Gomez, Łukasz Kaiser, and Illia Polosukhin. “Attention is all you need.” Advances in neural information processing systems 30 (2017), for further discussion of such attention mechanisms.

In the Detailed Match, the input to the transformer model is a concatenation of words, and the output includes an output corresponding to each of the input words (i.e., in a one-to-one relationship). The concatenation is augmented, for example, to add a “[CLS]” token at the start of the input, and a separator “[SEP]” between the question words and the document segment words, and a further “[SEP]” at the end of the input. As discussed below in regard to training, the output corresponding to the [CLS] token can be considered to be an output that represents the input as a whole, while each word of the question or the document segment also has a separate output. In the transformer model, each of the input words is first transformed into an embedding vector that is a mixture of a word embedding vector representing the word itself, an embedding vector representing the word being part of a question or part of the document segment and a position embedding representing the position in the sequence of input words. This sequence of embeddings is then passed through multiple layers of the transformer model, where these layers implement the attention mechanisms discussed above, with the final layer providing the outputs corresponding to the input words.

Three components of the outputs are of particular use in the Detailed Match. The output corresponding to the [CLS] token includes or is used to compute (e.g., with further neural network layers) a score that the document segment includes an answer to the question. In this way, by processing the question with multiple different document segments, the segments with the best scores can be identified as being the best candidates for containing the answer. Outputs corresponding to words in the document segment include or are used to compute two scores, or corresponding to whether that word is the start of an answer to the question, and another corresponding to whether the word is the end of the answer. Together, these scores can be used to identify the best subsequence of words that form the answer to the question, and the scores are used as further evidence of whether the subsequence is a true answer to the question.

Turning to training of the Detailed Match transformer, a detailed match dataset of questions and corresponding document segments with identification (annotation) of whether an answer appears in the segment and the start and end of such an answer. For example, the dataset is formed by manual curation of questions and answers in a particular domain. Training of the DM transformer generally makes use of conventional iterative updating of model parameters, for example, using gradient updates (e.g., using backpropagation) using small batches of the annotated question-segment pairs. The transformer model is usually initialized on another task, for example, in a masked language model task, and then the model parameters are further trained on the DM training dataset.

During query runtime, with sufficient computation capacity, the Detailed Match might be performed on all document segments that have been ingested into the system to find a best (or possibly a set of best) answer to the question. But as discussed earlier in this document, such exhaustive searching may not be feasible.

Now turning to the Fast Match (FM) stage that precedes the Detailed Match (DM) stage when a question is received, the FM also makes use of transformer models using the “two-leg-BERT” (described in U.S. application Ser. No. 17/358,829). There are two transformers used in this stage. One transformer is used to process the question, and the second transformer is used to process the document segment. Although in principle the same transformer architecture is used to process both the question and the segment, two different transformer models are trained, one producing a single [CLS] vector for the Question and the other one producing another [CLS] vector for the document segment. To assess whether a question is answered in a particular document segment, two vectors are compared: a first vector resulting from processing the question with the first transformer model (e.g., the vector output corresponding to the [CLS] token that is prepended to the question), and a second vector resulting from processing the document segment with the second transformer model. A score is determined by comparing these vectors, for example, using an inner product or cosine similarity measure.

During query runtime, while the vector for a question cannot be computed until the question is known, the vectors for the document segments can be pre-computed at the time the documents are ingested because at that time, as discussed below, the transformer models have already been trained. So, while the documents are being ingested and segmented (or thereafter but before the question is received) a vector representation is determined for each document segment using the second transformer model as described above and stored for later retrieval. When during the query runtime stage the question is received, the vector for that question is computed using the first FM transformer model, and then that vector is compared to retrieved vectors for the document segments to find the subset of document segments that have the best scores.

Training of the two transformer models for the two-leg BERT Fast Match makes use of the same or similarly curated training dataset. Note that while an indicator of whether a document segment contains the answer to a paired question is needed for this training, the start and end words for the answer are not. The Fast Match stage is concerned with identifying the best matching segments, and it is the Detailed Match that is used to determine the specific subsequence containing the answer in the 21um21ciateed best segment.

The two transformer models are trained together by adjusting the parameters to result in the comparison of the vectors matching as closely as possible the annotations in the training dataset. For example, a difference between the true indicator and the prediction resulting from the comparison of the two vectors (i.e., a “loss function”) is backpropagated through both models during the training procedure. The result is that the two transformer models for the Fast Match are not necessarily the same. As with the Detailed Match training, in some examples the transformers are initialized on training for another task, for example, starting with pretrained transformers for a masked language model, and then the Fast Match training dataset is used to further update the model parameters.

In some embodiments, there are further stages of fast match. For example, a term-frequency inverse-document-frequency (TF-IDF) approach is used in addition to the transformer based fast match. For example, each document segment and the question are treated as a “document” and a TF-IDF document similarity is computed between the question “document” and each of the document segment “documents.” For example, the TF-IDF approach is implemented as described in Salton, Gerard, and Christopher Buckley. “Term-weighting approaches in automatic text retrieval.” Information processing & management 24, no. 5 (1988): 513-523.

When both a TF-IDF and the two-leg BERT approach for Fast Match are used, they may be used in sequence or together. In sequence, the TF-IDF approach may be used to determine a first subset of matching document segments for a question, and then the two-leg BERT approach may be used to determine a second subset that is a subset of the first subset (i.e., further narrowing down the number of candidate segments). Together, both the scores from TF-IDF and two-leg BERT approaches may be fused together (e.g., added) to form a combined score to determine the candidate set of segments. Training for such approaches may be in the context of the combination of TF-IDF and two-leg BERT. For example, for the sequential approach, the transformer training may focus on training pairs that are passed through the TF-IDF stage rather than over the full dataset. For the combined approach, the transformer models may be trained in the context of addition with the TF-IDF scores rather than independently, essentially training the transformers to provide a fine correction to the TF-IDF scores.

Note that the result of the Detailed Match may be a single document segment and subsequence identified as the answer based on the output of the Detailed Match transformer. In some embodiments, the Detailed Match yields a set of possible answers, one for each associated document segment, for example, the 10 best answers & segments from a set of 1000 segment candidates identified by the Fast Match. These DM answers & segments may be further processed to yield the system's answer to present to the user. Such further processing (e.g., “post processing”) may involve one or more of determining representative different answers based on clustering by similarity, or summarization/combination using a large language model (LLM). In the latter case, a prompt may be formed from the question and the documents segments and/or the answers identified in the document segments, along with a directive such as “Please answer the following question based on the following passages and possible answers” and that prompt may then be provided as input to a generative LLM (e.g., ChatGPT), to determine the overall system answer to be provided in response to the question.

Additional details of the approaches described above can be found in PCT Application No. PCT/US2021/039145, the entire contents of which are incorporated herein by reference.

### 4.2 Summary and Fluency Module

The m document segments, A_{nE-1m} output from the extractive QA module 122 and the canonical query, \tilde{Q}ₙ are provided to the summary and fluency module 124 as input. In some examples, the summary and fluency module 124 uses a GLLM to determine a “best” answer, A_{nG} from the m document segments, A_{nE-1m}. For example, the summary and fluency module 124 uses a generative LLM to answer the question “What is the best answer to the following query based on the following document segments?”. In some examples, the summary and fluency module 124 will simply choose the best answer from one of the document segments. In other examples, the summary and fluency module 124 synthesizes its answer from the document segments and possibly from generalized knowledge built into the generative LLM.

### 4.3 Attribution Matching Module

The answer, A_{nG} output by the summary and fluency module 124 is provided to the attribution matching module 126, which determines whether the answer, A_{nG} can be attributed to any of the m document segments, A_{nE-1m}. If the answer to that question is yes, then the document segment associated with A_{nG} and its associated score(s) is output from the unstructured QA module 106 as the second candidate answer to the query, A_{nG-WA}.

In some examples, the attribution matching module 126 is implemented as an extractive large language model (ELLM) that is specifically trained to classify answers as having or not having attribution.

### 4.4 Hallucination Detection Module

Referring to FIG. 5, if the attribution matching module 126 determines that the answer, A_{nG} cannot be attributed to any of the m document segments, A_{nE-1m}, then A_{nG} is provided to the hallucination detection module 128. The hallucination detection module 128 processes the answer, A_{nG} as being either an incorrect hallucination or an answer that is correct but is not attributable to the collection of documents.

One example of a situation where the answer is correct but not attributable to the collection of documents is when information about a company's new CEO has been used to train the summary and fluency module, but information about the company's new CEO is not yet included in the company's collection of documents.

If the hallucination detection module 128 determines that the answer is correct but not attributable to the collection of documents, then it outputs the answer, A_{nG} as A_{nG-NA} from the unstructured QA module 106 as the second candidate answer to the query. Otherwise, the hallucination detection module 128 outputs the top extractive answer A_{nE-1} as the second candidate answer to the query (e.g., with a low confidence score indicating that it is likely a hallucination).

In some examples, the hallucination detection module 128 is implemented as a generative large language model (GLLM) that is specifically tuned to classify answers as hallucinations or non-hallucinations (as described in greater detail below).

### 5 Orchestration Module

Referring back to FIG. 1, the first candidate answer to the query (A_{nS}) and the second candidate answer to the query (A_{nG-WA}, A_{nG-NA}, or A_{nE-1}) are provided, along with their respective confidence scores, to the orchestration module 108, which determines which candidate answer to output as the final answer, Aₙ. In some examples, the orchestrator selects between the two candidate answers by comparing their confidence scores and selecting the candidate answer with the highest confidence score.

### 6 Training

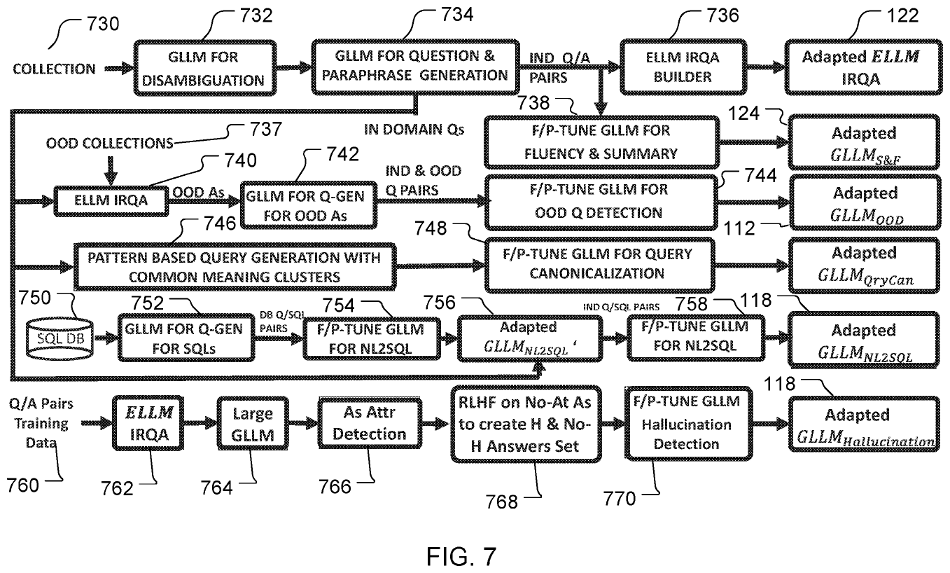

Referring to FIG. 7, a training system 100 is configured to train the large language models used in the system described above. The system receives an ingested version of the collection of data 730 as input. In some examples, the collection of data includes a number of documents, and the ingested collection of data 730 includes a segmentation of those documents, where each document is divided into multiple document segments (e.g., by paragraph or by number of words, such as 200-word segments). The ingested collection of data 730 is processed in a generative LLM (GLLM) for disambiguation 732, which disambiguates each document segment in a manner similar to the query disambiguation described above, by resolving ellipsis and coreferences.

The disambiguated segments generated by the disambiguation GLLM 732 are provided to a question generation GLLM 734, which is configured to generate question/answer pairs for each of the disambiguated segments. In some examples, the question generation GLLM 734 generates a set of questions and paraphrases of those questions that can be answered by the segment. The segments and the questions and paraphrases generated for the segments are output by the question generation GLLM 734 as question/answer pairs.

The question/answer pairs are provided to an ELLM IRQA builder 736, which trains a customized ELLM IRQA for the new collection using the question/answer pairs as training data. In some examples, training of the ELLM IRQA 122 makes use of conventional iterative updating of model parameters, for example, using gradient updates (e.g., using backpropagation) using small batches of the question/answer pairs. The transformer model is usually initialized on another task, for example, in a masked language model task, and then the model parameters are further trained on the question/answer pairs.

The question/answer pairs are also provided to a fluency and summary training module 738, which trains the summary and fluency GLLM 124 using the question/answer pairs as training data. Very generally, fine-tuning and/or prompt-tuning are used to tune a generic GLLM to generate a “best” answer to a question based on a set of candidate answers (as is described above), resulting in the summary and fluency GLLM 124.

The questions generated by the question generation LLM 734 are “in-domain” questions because they are generated from the collection of data. To train the out-of-domain detection LLM 112, the in-domain questions and segments from an “out-of-domain” collection of data 737 are provided to an ELLM IRQA 740 (e.g., the ELLM IRQA 122), which identifies answers as segments in the out-of-domain collection that answer the “in-domain” questions. The out-of-domain answers are provided to an out-of-domain” question generation GLLM 742, which generates a set of questions and paraphrases of those questions that can be answered by the out-of-domain answer segments. These questions are the types of out-of-domain questions that the out-of-domain detection LLM 112 is configured to identify. The paired in-domain and out-of-domain questions are provided to an out-of-domain detection training module 744, which trains the out-of-domain detection LLM 112 using the in-domain and out-of-domain questions as training data. Very generally, fine-tuning and/or prompt-tuning are used to tune a generic GLLM to classify a question as either being in-domain or out-of-domain (as is described above), resulting in the out-of-domain detection LLM 112. In some examples, heuristics are used to limit the scope of the out-of-domain collection. For example, clustering methods are used to break available large texts of all kinds into clusters. Then a fast matching operation is performed between the new collection and the clusters. Those clusters that are far by distance or are far by business metrics are selected as the out-of-domain collection, where the out of domain collection is 20-50% the size of the in-domain collection.

To train the query canonicalization LLM 114, for each segment of the collection of data, a pattern-based query generator 746 generates a set of related questions that are answerable by the segment. In some examples, the questions are automatically generated (e.g., using a GLLM) and in other examples the questions are human generated. In general, the generated questions are related in that they all seek the same answer (e.g., “To troubleshoot your VPN, first . . . ”), but they may ask for that answer in different ways (e.g., “why isn't my VPN working?,” “I can't connect to my VPN,” “how do I fix my VPN?”, or “is my VPN offline?”). The pattern-based query generator 746 processes the generated questions to select one of the questions as being a canonical question for accessing the answer (e.g., using a K-means clustering approach, where the canonical question is the centroid of a cluster of related questions). The query canonicalization training module 748 is then used to train the query canonicalization LLM 114 to map all the related questions to the canonical question (which in turn maps to a related answer in the segment). Very generally, fine-tuning and/or prompt-tuning are used to tune a generic GLLM to map related questions to the canonical question, resulting in the query canonicalization LLM 114.

To train the NL2SQL LLM 118, a number of SQL queries from a SQL database 750 are processed in a GLLM for question generation 752 to generate natural language (NL) questions that correspond to the SQL queries. The natural language question/SQL query pairs are provided to a NL2SQL training module 754, which uses fine-tuning and/or prompt-tuning to tune a generic GLLM to generate a non-collection specific NL2SQL GLLM 756. The collection-specific questions generated by the GLLM for question and paraphrase generation 734 are then processed in the non-collection specific NL2SQL GLLM 756 to generate collection-specific NL question/SQL query pairs. Finally, the collection-specific NL question/SQL query pairs are used by another NL2SQL training module 758 to fine-tune/prompt tune the non-collection specific NL2SQL GLLM 756, resulting in the collection-specific NL2SQL GLLM 118.

To train the hallucination detection LLM 128, training data 760 is processed in an ELLM IRQA module 762, a large GLLM 764, and an attribution detection module 766 to generate a set of answers, where some of the answers have attributions and some of the answers do not have attributions. In a next step 768, humans review the answers without attribution and mark them as being either hallucinations or non-hallucinations. The marked answers are used by a hallucination detection LLM training module 770 to fine-tune and/or prompt tune a generic LLM to classify answers without attribution as being either hallucinations or non-hallucinations, resulting in the hallucination detection LLM 128.

### 7 Alternatives

It is noted that the extractive QA module described with reference to FIG. 4 can be used without the other LLMs described above to answer questions about a collection of documents. The additional LLMs for pre-processing queries, accessing structured data, and determining attributions are optional—some or all of the additional LLMs can be used to improve the overall question-answering ability of the system in situations where doing is necessary.

As is noted above, the approaches described above may be used in combination with the approaches described one or more of the following PCT Applications, all of which are incorporated herein by reference: PCT/US2021/039145, PCT/US2023/027053, PCT/US2023/027317, PCT/US2023/027320, PCT/US2023/027316, and PCT/US2023/027315.

### 8 Implementations

The computational resource allocation approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program, for example, that provides services related to the design, configuration, and execution of data processing graphs. The modules of the program (e.g., elements of a data processing graph) can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs), dedicated, application-specific integrated circuits (ASICs), or graphics processing units GPUs (e.g., for efficient execution of large language models or other machine learning/artificial intelligence models). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

1. A question answering system configured to extract answers to queries from a collection of data, the system comprising:
an extractive stage configured to receive a query and to determine one or more answers to the query from the collection of data; and
one or more generative large language model stages configured to pre-process the query before it is provided to the extractive stage and/or to post-process the answers to the query.

2. The system of claim 1 wherein at least some of the generative large language models are collection-specific.

3. The system of claim 1 wherein the generative large language models are fine-tuned and/or prompt tuned according to the collection of data.

4. The system of claim 1 wherein at least some of the generative large language models are collection agnostic.

5. The system of claim 1 wherein at least some of the generative large language models are collection-specific and at least some of the generative large language models are collection agnostic.

6. The system of claim 1 wherein the one or more generative large language model stages configured to pre-process the query include a generative large language model stage for query disambiguation and a generative large language model stage for query canonicalization.

7. The system of claim 1 wherein the one or more generative large language model stages configured to process the query further include a generative large language model for out of domain query detection and a generative large language model for chitchat detection.

8. The system of claim 1 wherein the extractive stage includes an extractive large language model configured to generate a plurality of answers to the query.

9. The system of claim 1 wherein the one or more generative large language model stages configured to post-process the answers to the query include a summary and fluency generative large language model stage configured to process the query and the plurality of answers to generate a single answer to the query.

10. The system of claim 1 wherein the system further comprises a second extractive stage configured to determine if the single answer is attributable to the collection of data.

11. The system of claim 1 wherein the one or more generative large language model stages configured to process the answers further include a hallucination detection large language model stage configured to determine whether the single answer is a hallucination.

12. The system of claim 1 further comprising a structured data retrieval stage and an orchestration module, wherein the one or more generative large language model stages configured to process the answers are configured to generate an unstructured answer to the query and the structured data retrieval stage is configured to generate a structured answer to the query, and the orchestration module is configured to choose the best answer from the structured answer and the unstructured answer.

13. The system of claim 1 wherein the orchestration module chooses the best answer based on a comparison of a first confidence score associated with the structured answer and a second confidence score associated with the unstructured answer.

14. The system of claim 1 wherein the extractive stage includes a relational database.

15. The system of claim 1 wherein the one or more generative large language model stages configured to pre-process the query include a generative large language model configured to convert a natural language query to a SQL query.

16. A method including steps for implementing the system of claim 1.

17. Software embodied on a non-transitory, tangible computer-readable medium, the software including instructions for causing a computing system implement the system of claim 1.

18. A method for training a collection-specific generative large language model for forming a SQL representation of a natural language query, the method comprising:
processing a plurality of SQL queries in a generative large language model to determine a corresponding plurality of natural language representations of the SQL queries;
training an intermediate generative large language model to convert natural language representations of SQL queries to SQL queries using the plurality of SQL queries and corresponding plurality of natural language representations of the SQL queries;
processing a plurality of collection-specific natural language queries using the intermediate generative large language model to convert the collection-specific natural language queries to collection-specific SQL queries; and
training the collection-specific generative large language model to convert natural language queries to collection-specific SQL queries using the plurality of collection-specific natural language queries and the corresponding plurality of collection-specific SQL queries.
